(19) United States
(12) Patent Application Publication
(10) Pub. No.: US 2026/0011133 A1
(43) Pub. Date: Jan. 8, 2026

(54) METHOD AND APPARATUS WITH NEURAL NETWORK BASED IMAGE PROCESSING

(71) Applicants: Samsung Electronics Co., Ltd., Suwon-si (KR); Korea University Research and Business Foundation, Seoul (KR)

(72) Inventors: Jong-Ok KIM, Seoul (KR); Dong-Hoon KANG, Suwon-si (KR); Dong-Keun HAN, Seoul (KR)

(73) Assignees: Samsung Electronics Co., Ltd., Suwon-si (KR); Korea University Research and Business Foundation, Seoul (KR)

(21) Appl. No.: 19/258,619

(22) Filed: Jul. 2, 2025

(30) Foreign Application Priority Data
Jul. 3, 2024 (KR) 10-2024-0087500

(51) Int. Cl. G06V 10/82; G06V 10/77

(52) U.S. Cl. CPC G06V 10/82; G06V 10/7715

(57) ABSTRACT

A processor-implemented method including converting an input image based on first sub-images of first color channels into a multispectral image based on second sub-images of second color channels, generating an illumination map representing an illumination configuration of the input image, based on the input image, generating a confidence score map of the illumination map, based on the multispectral image, and determining illuminant information of the input image by fusing the illumination map with the confidence score map, a second number of channels of the second color channels being greater than a first number of channels of the first color channels.

### CROSS-REFERENCE TO RELATED APPLICATIONS

This application claims the benefit under 35 USC § 119(a) of Korean Patent Application No. 10-2024-0087500, filed on Jul. 3, 2024, in the Korean Intellectual Property Office, the entire disclosure of which is incorporated herein by reference for all purposes.

### BACKGROUND

### 1. Field

The following description relates to a method and apparatus with neural network based image processing.

### 2. Description of Related Art

A deep learning-based neural network may be used for image processing. The neural network may be trained based on deep learning, and then perform an inference for a desired purpose by mapping input data and output data that are in a nonlinear relationship with each other. This typical, trained capability of generating the mapping may be referred to as a learning ability of the neural network. The neural network trained for a special purpose such as image restoration may have a generalization ability to generate a relatively accurate output in response to an input pattern that is not yet trained.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including converting an input image based on first sub-images of first color channels into a multispectral image based on second sub-images of second color channels, generating an illumination map representing an illumination configuration of the input image, based on the input image, generating a confidence score map of the illumination map, based on the multispectral image, and determining illuminant information of the input image by fusing the illumination map with the confidence score map, a second number of channels of the second color channels being greater than a first number of channels of the first color channels.

The generating of the illumination map may include extracting a spatial feature from the input image using a spatial feature extraction model and generating the illumination map based on the spatial feature using an illumination estimation model.

The generating of the confidence score map may include extracting a spectral feature from the multispectral image using a spectral feature extraction model and generating the confidence score map based on the spectral feature using a confidence estimation model.

The extracting of the spectral feature may include generating a spatial attention map based on a spatial feature of the multispectral image, generating a spectral attention map based on a spectral feature of the multispectral image, generating a cross attention map based on the spatial attention map and the spectral attention map, and generating the spectral feature using the cross attention map.

The multispectral image may be defined based on a width direction, a height direction, and a channel direction, the spatial feature may be extracted based on the width direction and the height direction, and the spectral feature may be extracted based on the channel direction.

The generating of the spatial attention map may include generating a query spatial feature based on a first spatial embedding of the multispectral image, generating a key spatial feature based on a second spatial embedding of the multispectral image, and generating the spatial attention map based on a matrix operation between the query spatial feature and the key spatial feature.

The generating of the spectral attention map may include generating a query spectral feature based on a first spectral embedding of the multispectral image, generating a key spectral feature based on a second spectral embedding of the multispectral image, and generating the spectral attention map based on a matrix operation between the query spectral feature and the key spectral feature.

The generating of the spectral feature may include generating a value spectral feature based on a third spectral embedding of the multispectral image and generating the spectral feature based on a matrix operation between the cross attention map and the value spectral feature.

The first color channels may include a red channel, a green channel, and a blue channel, and the second color channels may include a color channel between the red channel and the green channel, a color channel between the green channel and the blue channel, or a combination thereof.

In a general aspect, here is provided a processor-implemented method including converting an input image based on first sub-images of first color channels into a multispectral image based on second sub-images of second color channels, generating an illumination map representing an illumination configuration of the input image and a confidence score map of the illumination map, based on the multispectral image, and determining illuminant information of the input image by fusing the illumination map with the confidence score map, a number of channels of the second color channels being greater than a number of channels of the first color channels.

The generating of the confidence score map may include extracting a spectral feature from the multispectral image using a spectral feature extraction model and generating the confidence score map based on the spectral feature using a confidence estimation model.

The extracting of the spectral feature may include generating a spatial attention map based on a spatial feature of the multispectral image, generating a spectral attention map based on a spectral feature of the multispectral image, generating a cross attention map based on the spatial attention map and the spectral attention map, and generating the spectral feature using the cross attention map.

The first color channels may include a red channel, a green channel, and a blue channel, and the second color channels may include a first spectral channel between the red channel and the green channel, a second spectral channel between the green channel and the blue channel, or a combination thereof.

In a general aspect, here is provided a non-transitory computer-readable storage medium storing instructions that, when executed by a processor, cause the processor to perform the method.

In a general aspect, here is provided an electronic device including processors configured to execute instructions and a memory storing the instructions, and an execution of the instructions configures the processors to convert an input image based on first sub-images of first color channels into a multispectral image based on second sub-images of second color channels, generate an illumination map representing an illumination configuration of the input image, based on the input image, estimate a confidence score map of the illumination map, based on the multispectral image, and determine illuminant information of the input image by fusing the illumination map with the confidence score map, and a number of channels of the second color channels being greater than a number of channels of the first color channels.

The one or more processors may be further configured to extract a spectral feature from the multispectral image using a spectral feature extraction model and estimate the confidence score map based on the spectral feature using a confidence estimation model.

The one or more processors may be further configured to generate a spatial attention map based on a spatial feature of the multispectral image, generate a spectral attention map based on a spectral feature of the multispectral image, generate a cross attention map based on the spatial attention map and the spectral attention map, and generate the spectral feature using the cross attention map.

The one or more processors may be further configured to generate a query spatial feature based on a first spatial embedding of the multispectral image, generate a key spatial feature based on a second spatial embedding of the multispectral image, and generate the spatial attention map based on a matrix operation between the query spatial feature and the key spatial feature.

The one or more processors may be further configured to generate a query spectral feature based on a first spectral embedding of the multispectral image, generate a key spectral feature based on a second spectral embedding of the multispectral image, and generate the spatial attention map based on a matrix operation between the query spectral feature and the key spectral feature.

The first color channels may include a red channel, a green channel, and a blue channel, and the second color channels may include a first spectral channel between the red channel and the green channel, a second spectral channel between the green channel and the blue channel, or a combination thereof.

Other features and aspects will be apparent from the following detailed description, the drawings, and the claims.

### BRIEF DESCRIPTION OF THE DRAWINGS

FIG. 1 illustrates an example process of estimating illumination information by generating an illumination map and a confidence score map from an input image and a multispectral image according to one or more embodiments.

FIG. 2 illustrates an example channel configuration of each of an input image and a multispectral image according to one or more embodiments.

FIG. 3 illustrates an example a first neural network model according to one or more embodiments.

FIG. 4 illustrates an example a second neural network model according to one or more embodiments.

FIG. 5 illustrates an example process of extracting a spectral feature from a multispectral image according to one or more embodiments.

FIG. 6 illustrates an example white balancing operation using an illuminant vector according to one or more embodiments.

FIG. 7 illustrates an example process of estimating illumination information by generating an illumination map and a confidence score map from a multispectral image according to one or more embodiments.

FIG. 8 illustrates an example process of training a first neural network model and a second neural network model using a hierarchical structure according to one or more embodiments.

FIG. 9 illustrates an example process of deriving a similarity score map used for model training according to one or more embodiments.

FIG. 10 illustrates an example process of training a student network model corresponding to an image transformation model using feature distillation according to one or more embodiments.

FIG. 11 illustrates an example process of training a first neural network model and a second neural network model without a hierarchical structure according to one or more embodiments.

FIG. 12 illustrates an example image processing method according to one or more embodiments.

FIG. 13 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

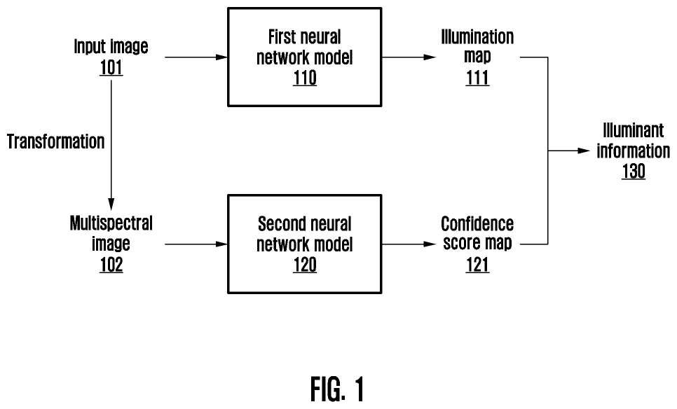

FIG. 1 illustrates an example process of estimating illumination information by generating an illumination map and a confidence score map from an input image and a multispectral image according to one or more embodiments.

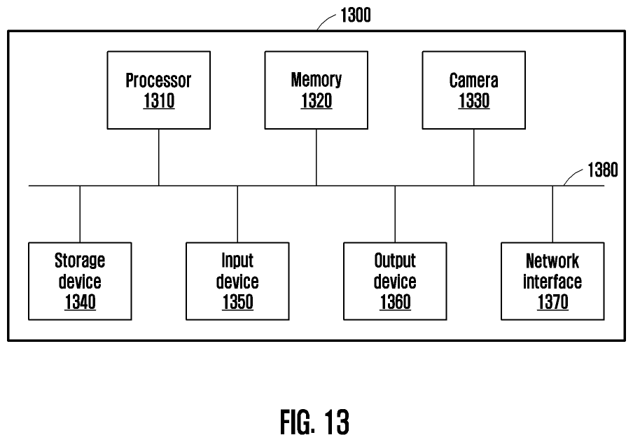

Referring to FIG. 1, in a non-limiting example, an electronic device (e.g., electronic device 1300 of FIG. 13) may convert an input image 101 into a multispectral image 102. A neural network-based image transformation model may be used for image transformation. The electronic device may estimate an illumination map 111 representing an illumination configuration of the input image 101, based on the input image 101, and may estimate a confidence score map 121 of the illumination map 111 based on the multispectral image 102. In an example, the electronic device may generate the illumination map 111 based on the input image 101 and may generate the confidence score map 121 of the illumination map 111 based on the multispectral image 102.

In an example, the electronic device may determine illuminant information 130 of the input image 101 by fusing the illumination map 111 with the confidence score map 121. The illuminant information 130 may include an illuminant vector. For example, when the input image 101 is a red, green, and blue (RGB) image, the illuminant vector may include a red (R) channel illumination value, a green (G) channel illumination value, and a blue (B) channel illumination value. For example, the electronic device may use the illuminant information 130 for white balance of the input image 101.

The input image 101 may be based on first sub-images of first color channels. The input image 101 may be generated by fusing the first sub images, and the input image 101 may be decomposed into the first sub-images. For example, the first color channels may include an R channel, a G channel, and a B channel. In this case, the input image 101 may be generated by fusing a sub-image of the R channel, a sub-image of the G channel, and a sub-image of the B channel.

In an example, the multispectral image 102 may be based on second sub-images of second color channels. The multispectral image 102 may be generated by fusing the second sub-images, and the multispectral image 102 may be decomposed into the second sub-images. The number of channels of the second color channels may be greater than the number of channels of the first color channels. The input image 101 may have a dimension of W*H*C1 and the multispectral image 102 may have a dimension of W*H*C2. W may represent a width, H may represent a height, and C1 and C2 may represent channels. When the first color channels include the R channel, the G channel, and the B channel, C1 may be 3. In addition, C2 may be greater than C1.

The illumination map 111 may include a pixelwise illumination value of the input image 101. The confidence score map 121 may include a confidence score of an illumination value of each pixel of the illumination map 111. The electronic device may estimate or generate the illumination map 111 using a first neural network model 110 and may estimate or generate the confidence score map 121 using a second neural network model 120.

In an example, neural network models, such as the first neural network model 110 and the second neural network model 120, may include a deep neural network (DNN) including a plurality of layers. The plurality of layers may include an input layer, at least one hidden layer, and an output layer.

The DNN may include at least one of a fully connected network (FCN), a convolutional neural network (CNN), or a recurrent neural network (RNN). For example, at least some of the layers included in the neural network may correspond to the CNN, and the others may correspond to the FCN. The CNN may be referred to as a convolutional layer, and the FCN may be referred to as a fully connected layer.

In the case of the CNN, data input to each layer may be referred to as an input feature map, and data output from each layer may be referred to as an output feature map. The input feature map and the output feature map may also be referred to as activation data. When a convolutional layer corresponds to an input layer, an input feature map of the input layer may be an image.

The neural network may be trained based on deep learning and perform inference suitable for a training purpose by mapping input data and output data that are in a nonlinear relationship with each other. Deep learning is a machine learning technique for solving a problem such as image or speech recognition from a big data set. Deep learning may be construed as an optimization issue solving process of finding a point at which energy is minimized while training a neural network using prepared training data.

Through supervised or unsupervised learning of deep learning, a structure of the neural network or a weight corresponding to a model may be obtained, and the input data may be mapped to the output data by using the weight. If the width and the depth of the neural network are sufficiently large, the neural network may have a capacity capable of implementing a predetermined function. The neural network may achieve an optimized performance when learning a sufficiently large amount of training data through an appropriate training process.

The neural network may be expressed as being trained in advance, where “in advance” means before the neural network “starts”. That the neural network “starts” means that the neural network is ready for inference. For example, a “start” of the neural network may include loading of the neural network in a memory, or an input of input data for inference to the neural network after the neural network is loaded in a memory.

In an example, the multispectral image 102 may include image information of more color channels than the input image 101. The accuracy of the illuminant information 130 estimated using the multispectral image 102 may be higher than the accuracy of the illuminant information 130 estimated using the input image 101. Since a general camera uses a limited number of color channels such as RGB, it is difficult to obtain the multispectral image 102 through a general camera. According to an example, the multispectral image 102 may be estimated from the input image 101 and the illuminant information 130 of high accuracy may be obtained using the multispectral image 102.

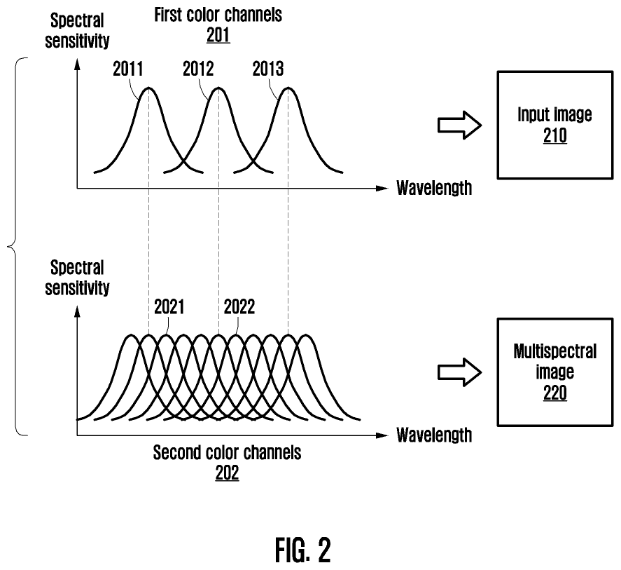

FIG. 2 illustrates an example channel configuration of each of an input image and a multispectral image according to one or more examples.

Referring to FIG. 2, in a non-limiting example, an input image 210 may be based on first color channels 201 and a multispectral image 220 may be based on second color channels 202. The number of channels of the second color channels 202 may be greater than the number of channels of the first color channels 201. The first color channels 201 and the second color channels 202 may belong to a visible light band, and the input image 210 and the multispectral image 220 may be visible light images.

The first color channels 201 may include color channels 2011, 2012, and 2013, and the second color channels 202 may include color channels 2021 and 2022. The second color channels 202 may include the color channel 2021 between the color channel 2011 and the color channel 2012, the color channel 2022 between the color channel 2012 and the color channel 2013, or a combination thereof. For example, the color channel 2011 may be an R channel, the color channel 2012 may be a G channel, and the color channel 2013 may be a B channel. In this case, the second color channels 202 may include the color channel 2021 between the R channel and the G channel, the color channel 2022 between the G channel and the B channel, or a combination thereof.

FIG. 3 illustrates an example a first neural network model according to one or more embodiments.

Referring to FIG. 3, in a non-limiting example, a first neural network model 300 may estimate, or generate, an illumination map 321 based on an input image 301. The first neural network model 300 may include a spatial feature extraction model 310 for extracting a spatial feature from the input image 301, and an illumination estimation model 320 for estimating, or generating, the illumination map 321 based on the spatial feature. The spatial feature extraction model 310 and the illumination estimation model 320 may be based on a neural network.

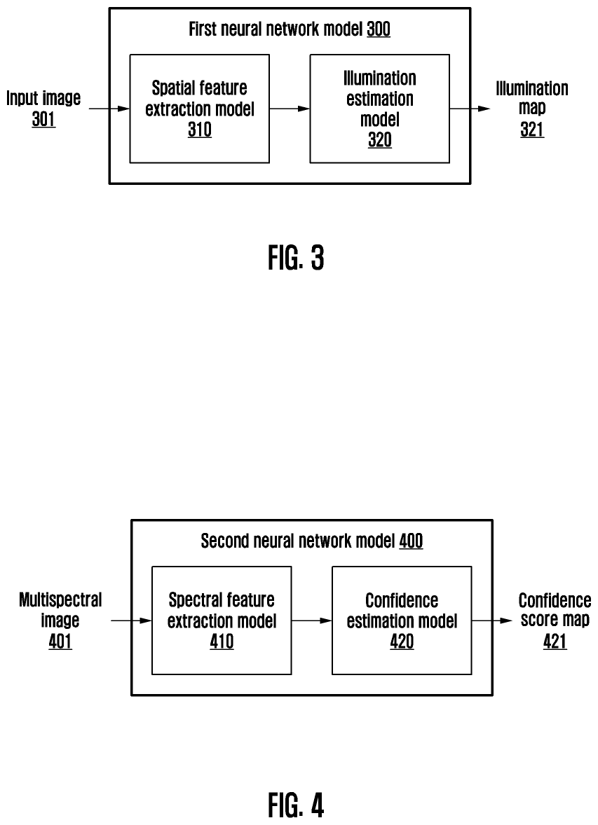

FIG. 4 illustrates an example of a second neural network model according to one or more embodiments.

Referring to FIG. 4, in a non-limiting example, a second neural network model 400 may estimate, or generate, a confidence score map 421 based on a multispectral image 401. The second neural network model 400 may include a spectral feature extraction model 410 for extracting a spectral feature from the multispectral image 401, and a confidence estimation model 420 for estimating, or generating, the confidence score map 421 based on the spectral feature. The spectral feature extraction model 410 and the confidence estimation model 420 may be based on a neural network.

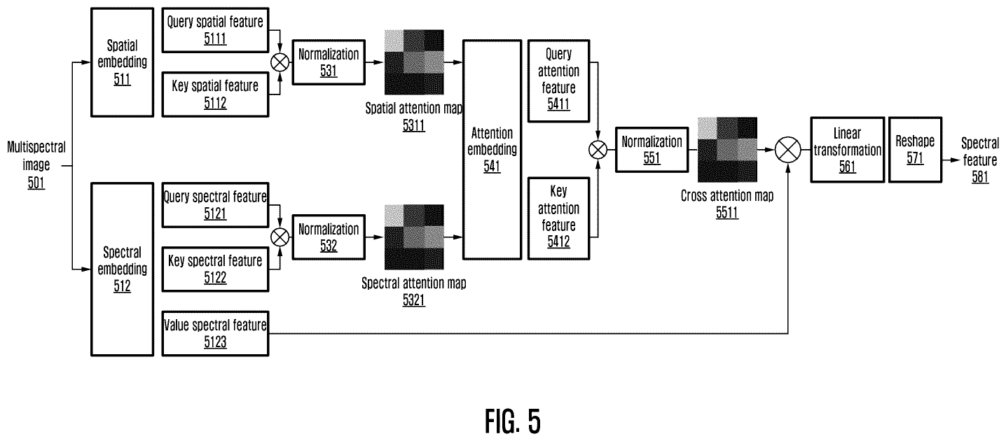

FIG. 5 illustrates an example process of extracting a spectral feature from a multispectral image according to one or more embodiments.

Referring to FIG. 5, in a non-limiting example, a spatial attention map 5311 may be generated based on a spatial feature of a multispectral image 501, and a spectral attention map 5321 may be generated based on a spectral feature of the multispectral image 501. The multispectral image 501 may be defined as (B, C2, H, W). B may represent the number of batches.

In an example, a query spatial feature 5111 and a key spatial feature 5112 may be generated based on a spatial embedding 511 of the multispectral image 501. The query spatial feature 5111 may be generated based on a first spatial embedding of the multispectral image 501, and the key spatial feature 5112 may be generated based on a second spatial embedding of the multispectral image 501. The query space feature 5111 and the key space feature 5112 may be defined as (B, C2, N), respectively. The spatial embedding 511 may be performed using an encoder such as a CNN or transformer. Different encoders may be used for each of the first spatial embedding and the second spatial embedding. The spatial attention map 5311 may be generated based on a matrix operation between the query space feature 5111 and the key space feature 5112. For example, a matrix multiplication operation between the query space feature 5111 and the key space feature 5112 may be performed, and the spatial attention map 5311 may be generated based on normalization 531 about an operation result of the matrix multiplication operation. For example, the normalization 531 may be performed based on softmax. The spatial attention map 5311 may be defined as (N, N).

In an example, a query spectral feature 5121 and a key spectral feature 5122 may be generated based on a spectral embedding 512 of the multispectral image 501. The query spectral feature 5121 may be generated based on a first spectral embedding of the multispectral image 501, the key spectral feature 5122 may be generated based on a second spectral embedding of the multispectral image 501, and a value spectral feature 5123 may be generated based on a third spectral embedding of the multispectral image 501. The query spectral feature 5121, the key spectral feature 5122, and the value spectral feature 5123 may be defined as (B, HW, N), respectively. The spectral embedding 512 may be performed using an encoder such as a CNN or transformer. Different encoders may be used for each of the first spectral embedding, the second spectral embedding, and the third spectral embedding. The spectral attention map 5321 may be generated based on a matrix operation between the query spectral feature 5121 and the key spectral feature 5122. For example, a matrix multiplication operation between the query spectral feature 5121 and the key spectral feature 5122 may be performed, and the spectral attention map 5321 may be generated based on normalization 532 about an operation result of the matrix multiplication operation. For example, the normalization 532 may be performed based on softmax. The spectral attention map 5321 may be defined as (N, N).

The multispectral image 501 may be defined based on a width direction, a height direction, and a channel direction. The multispectral image 501 may have a dimension of W*H*C2, where W may represent the width direction, H may represent the height direction, and C2 may represent the channel direction. A spatial feature of the multispectral image 501 may be extracted based on the width direction and the height direction. A spectral feature of the multispectral image 501 may be extracted based on the channel direction.

In an example, a cross attention map 5511 may be generated based on the spatial attention map 5311 and the spectral attention map 5321. A query attention feature 5411 and a key attention feature 5412 may be generated based on an attention embedding 541 of the spatial attention map 5311 and the spectral attention map 5321. The query attention feature 5411 may be generated based on the attention embedding 541 of the spatial attention map 5311, and the key attention feature 5412 may be generated based on the attention embedding 541 of the spectral attention map 5321. The query attention feature 5411 and the key attention feature 5412 may be defined as (1, N), respectively. The attention embedding 541 may be performed using an encoder such as a CNN or transformer. Different encoders may be used for each of the attention embedding 541 of the spatial attention map 5311 and the attention embedding 541 of the spectral attention map 5321. The cross attention map 5511 may be generated based on a matrix operation between the query attention feature 5411 and the key attention feature 5412. For example, a matrix multiplication operation may be performed between the query attention feature 5411 and the key attention feature 5412, and the cross attention map 5511 may be generated based on normalization 551 about an operation result of the matrix multiplication operation. For example, the normalization 551 may be performed based on softmax. The cross attention map 5511 may be defined as (N, N).

A spectral feature 581 may be generated using the cross attention map 5511. The spectral feature 581 may be generated based on a matrix operation between the cross attention map 5511 and the value spectral feature 5123. For example, a matrix multiplication operation may be performed between the cross attention map 5511 and the value spectral feature 5123, and the spectral feature 581 may be generated based on a linear transformation 561 and a reshape 571 on an operation result of the matrix multiplication operation. The operation result of the matrix multiplication operation may be defined as (B, HW, N), and the spectral feature 581 may be defined as (B, C, H, W).

In an example, the spatial feature of the multispectral image 501 and the spectral feature of the multispectral image 501 may be considered together. Accordingly, a greater weight may be given to spectral information of an important space. In an example, the importance of spatial information and the importance of spectral information may be simultaneously considered, and spectral information of the multispectral image 501 may be effectively extracted.

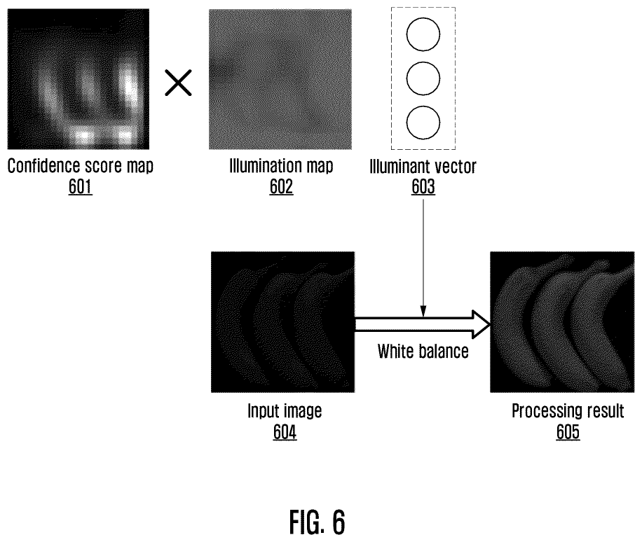

FIG. 6 illustrates an example white balancing operation using an illuminant vector according to one or more embodiments.

Referring to FIG. 6, in a non-limiting example, the electronic device (e.g., electronic device 1300 of FIG. 13) may obtain a weighted sum between a confidence score map 601 and an illumination map 602 and may determine illuminant information according to the weighted sum. For example, the illuminant information may include an illuminant vector 603. The illuminant vector 603 may include an R channel illumination value, a G channel illumination value, and a B channel illumination value. The illuminant vector 603 may be used for white balancing processing of an input image 604. An output image may be determined based on a processing result 605.

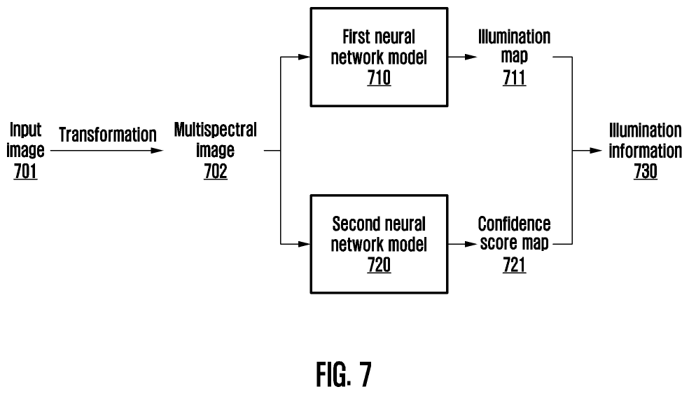

FIG. 7 illustrates an example process of estimating illumination information by generating an illumination map and a confidence score map from a multispectral image according to one or more embodiments.

Referring to FIG. 7, in a non-limiting example, the electronic device (e.g., the electronic device 1300 of FIG. 13) may convert an input image 701 into a multispectral image 702. The electronic device may input the multispectral image 702 into a first neural network model 710 to obtain an illumination map 711 and may input the multispectral image 702 into a second neural network model 720 to obtain a confidence score map 721. The electronic device may determine illumination information 730 by fusing the illumination map 711 with the confidence score map 721.

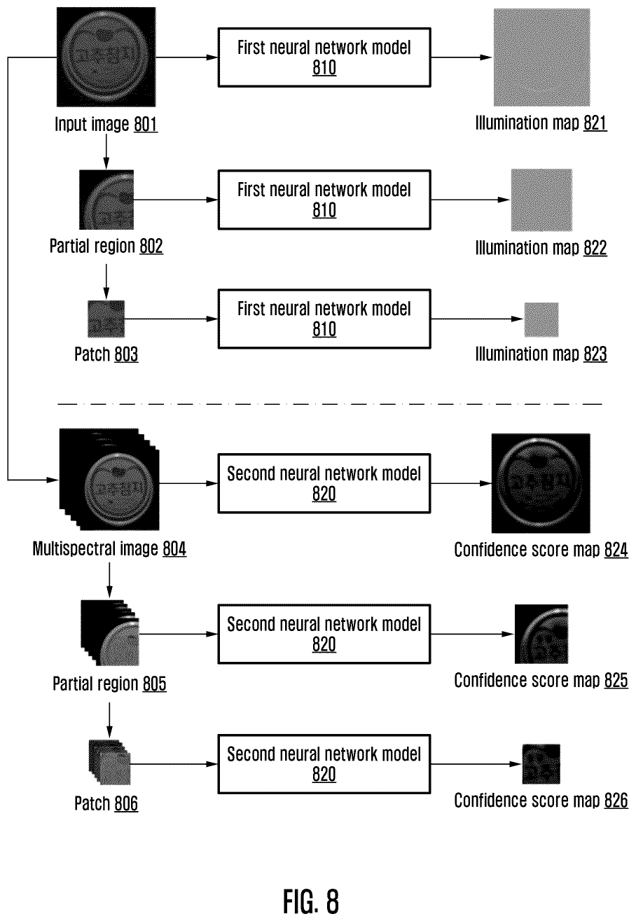

FIG. 8 illustrates an example process of training a first neural network model and a second neural network model using a hierarchical structure according to one or more embodiments.

Referring to FIG. 8, in a non-limiting example, a hierarchical structure may be used for training a first neural network model 810 and a second neural network model 820. The hierarchical structure may include a full image layer such as an input image 801 and a multispectral image 804, a partial region layer such as partial regions 802 and 805 of the input image 801 and the multispectral image 804, respectively, and a patch layer such as patches 803 and 806 of the input image 801 and the multispectral image 804, respectively. The partial region 802 may be extracted from the input image 801, and the patch 803 may be extracted from the partial region 802. The partial region 805 may be extracted from the multispectral image 804, and the patch 806 may be extracted from the partial region 805.

In an example, the input image 801, the partial region 802, and the patch 803 may each be input into the first neural network model 810, and illumination maps 821, 822, and 823 may be generated. The multispectral image 804, the partial region 805, and the patch 806 may each be input into the second neural network model 820, and confidence score maps 824, 825, and 826 may be generated. The first neural network model 810 and the second neural network model 820 may be trained based on an angular loss, an invariant loss, a contrastive loss, or a combination thereof.

In an example, the angular loss may be determined based on Equation 1 below.

$$L = {cos}^{- 1} ( \frac{{Γ}_{gt} \cdot {Γ}_{est}}{‖ {Γ}_{gt} ‖ ‖ {Γ}_{est} ‖} ) \qquad Equation 1$$

In Equation 1, L may denote an angular loss, Γₑₛₜ may denote an illuminant vector, and Γ_{gt} may denote ground truth (GT). In addition, L may denote an angular error between the illuminant vector Γₑₛₜ and the GT Γ_{gt}. Each illuminant vector may be determined based on a weighted sum of each of the illumination maps 821 to 823 and each of the confidence score maps 824 to 826, and L may be determined based on each illuminant vector.

In an example, the invariant loss may be determined based on Equation 2 below.

$${L}_{invar} = {\sum }_{m , n ∈ \{ full , area , patch \}} {‖ {Γ}_{m} - {Γ}_{n} ‖}_{1} \qquad Equation 2$$

In Equation 2, Lᵢₙᵥₐᵣ may denote an invariant loss. In Equation 2, “full” may denote a full image such as the input image 801 and the multispectral image 804, area may denote the partial regions 802 and 805, and patch may denote the patches 803 and 806. Also in Equation 2, Γₘ, and Γn may denote illuminant vectors obtained using full, area, and patch. According to Lᵢₙᵥₐᵣ, the first neural network model 810 and the second neural network model 820 may be trained so that the sum of the difference between an illuminant vector obtained using “full” and an illuminant vector obtained using area, the difference between the illuminant vector obtained using area and an illuminant vector obtained using patch, and the difference between the illuminant vector obtained using patch and the illuminant vector obtained using “full” becomes small.

In an example, the contrastive loss may be determined based on Equation 3 below.

$${L}_{con} = - log \frac{{\sum }_{[ k , l ∈ \{ 1 , 2 , 3 \} , k \neq 1 ]} {\sum }_{[ i , j ∈ \{ 1 … N \} , i = j ]} exp ( {S}_{ki} ( i , j ) / τ )}{{\sum }_{[ i , j ∈ \{ 1 … 3 N \} , i \neq j ]} exp ( S ( i , j ) / τ )} \qquad Equation 3$$

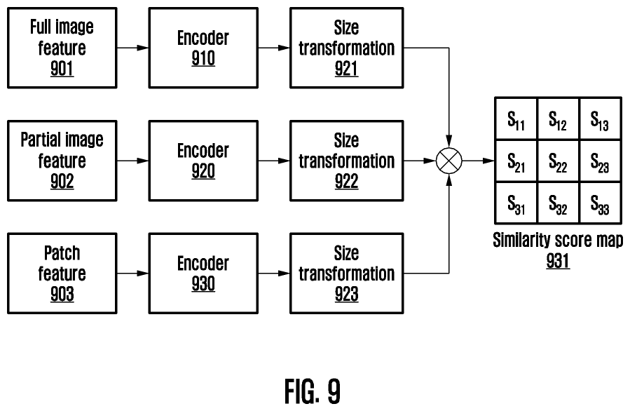

In Equation 3, L_{con} may denote a contrastive loss, S may denote a similarity score, and τ may denote an adjustment constant. Further description of the contrastive loss is discussed in greater detail below with reference to FIG. 9.

FIG. 9 illustrates an example process of deriving a similarity score map used for model training according to one or more embodiments.

Referring to FIG. 9, in a non-limiting example, encoding results for a full image feature 901, a partial image feature 902, and a patch feature 903 may be generated using encoders 910, 920, and 930. In the case of an input image, the full image feature 901, the partial image feature 902, and the patch feature 903 may be generated using a spatial feature extraction model of a first neural network model. In this case, the encoding results may be illumination maps. In the case of a multispectral image, the full image feature 901, the partial image feature 902, and the patch feature 903 may be generated using a spectral feature extraction model of a second neural network model. In this case, the encoding results may be confidence score maps.

Sizes of the encoding results may be adjusted to be the same through size transformation operations 921, 922, and 923. Outputs of the size transformation operations 921, 922, and 923 may be referred to as intermediate operation results. Each intermediate operation result may be vectorized, and the vectorized results may be concatenated to generate a single vector. A similarity score map 931 may be determined according to a vector multiplication operation using the single vector.

According to a batch operation, in an example, the full image feature 901, the partial image feature 902, and the patch feature 903 may include features of additional (i.e., other) images. In this case, it is desired that the similarity that is calculated for the similarity score map 931 between images that are different may be smaller (i.e., decreased similarity) and a calculated similarity between images that are the same should be greater (i.e., increased similarity). Thus, in the similarity score map 931, Sₖₗ may each correspond to a matrix. In the example of FIGS. 9, k and 1 may have values from 1 to 3. In addition, in FIG. 9, S may denote all Sₖₗ. Accordingly, Sₖₗ(i, j) may denote matrix elements of Sₖₗ and S(i, j) may denote matrix elements of S. For example, i may have values from 1 to N. According to the contrastive loss of Equation 3, diagonal elements corresponding to the similarity between images that are different in the similarity score map 931 may become smaller, and off-diagonal elements corresponding to the similarity between the images that are the same may become larger.

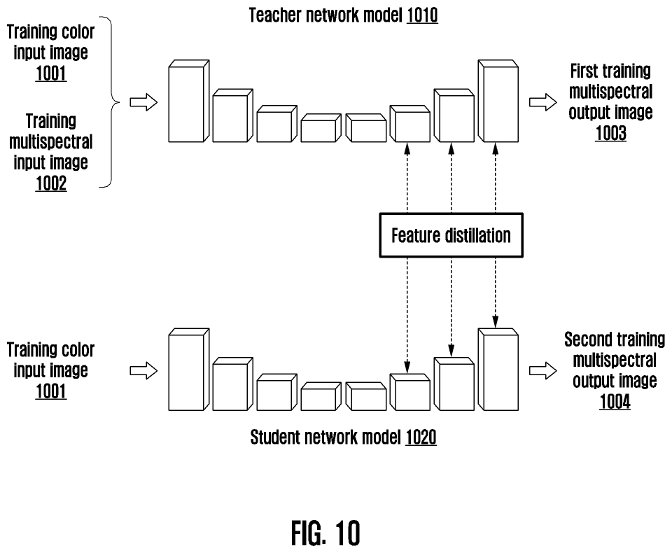

FIG. 10 illustrates an example process of training a student network model corresponding to an image transformation model using feature distillation according to one or more embodiments.

Referring to FIG. 10, in a non-limiting example, a teacher network model 1010 may generate a first training multispectral output image 1003, which is based on a training color input image 1001 and a training multispectral input image 1002. A student network model 1020 may generate a second training multispectral output image 1004 based on the training color input image 1001. The teacher network model 1010 may be trained to reduce a loss of the first training multispectral output image 1003, and the student network model 1020 may be trained to reduce a loss of the second training multispectral output image 1004.

Since the teacher network model 1010 additionally uses the training multispectral input image 1002, the teacher network model 1010 may have more information and may estimate the first training multispectral output image 1003 more accurately than the student network model 1020. The teacher network model 1010 may be transmitted to the student network model 1020 through feature distillation. Based on the feature distillation, an ability of the student network model 1020 to infer the second training multispectral output image 1004 from the training color input image 1001 may be improved.

In an example, an input image may be converted into a multispectral image, and the multispectral image may be used for estimating illumination information. According to an example, a neural network-based image transformation model may be used for image transformation. An image transformation model may be trained in an operation of the student network model 1020 and may transform the input image into the multispectral image.

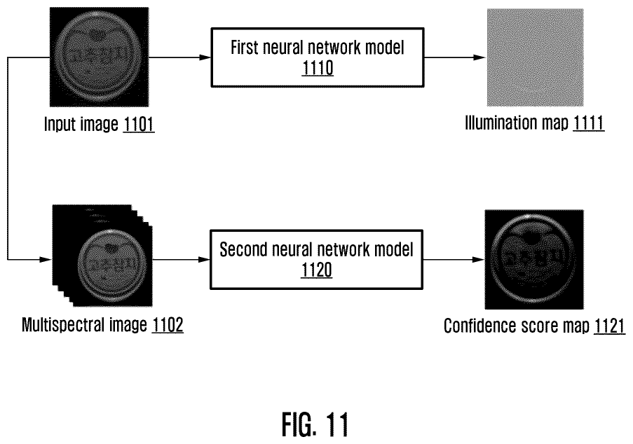

FIG. 11 illustrates an example process of training a first neural network model and a second neural network model without a hierarchical structure according to one or more embodiments.

Referring to FIG. 11, in a non-limiting example, a first neural network model 1110 may estimate, or generate, an illumination map 1111 based on an input image 1101, and a second neural network model 1120 may estimate, or generate, a confidence score map 1121 based on a multispectral image 1102. The example of FIG. 11, unlike the example of FIG. 8, may not use a hierarchical structure. In this case, the first neural network model 1110 and the second neural network model 1120 may be trained without one or more of an invariant loss and a contrastive loss.

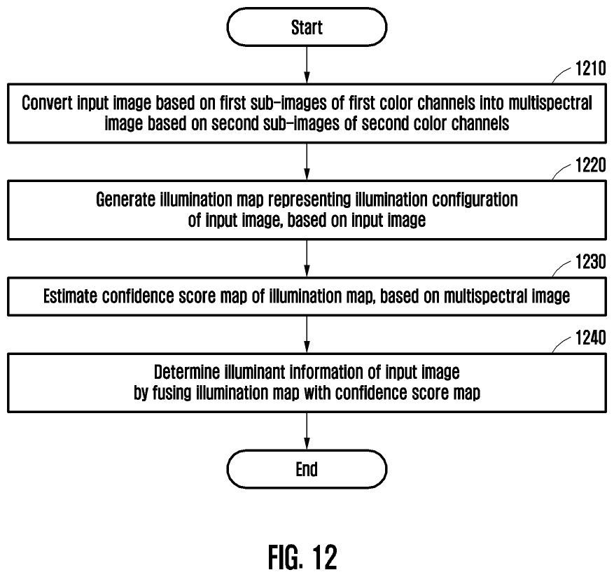

FIG. 12 illustrates an example image processing method according to one or more embodiments.

Referring to FIG. 12, in a non-limiting example, an electronic device (e.g., electronic device 1300 of FIG. 13) may convert an input image based on first sub-images of first color channels into a multispectral image based on second sub-images of second color channels, in operation 1210. In operation 1220, the method may estimate, or generate, an illumination map representing an illumination configuration of the input image, based on the input image. In operation 1230, the method may estimate a confidence score map of the illumination map, based on the multispectral image and may determine illuminant information of the input image by fusing the illumination map with the confidence score map, in operation 1240. The number of channels of the second color channels may be greater than the number of channels of the first color channels.

In an example, operation 1220 may include extracting a spatial feature from the input image using a spatial feature extraction model and estimating the illumination map based on the spatial feature using an illumination estimation model. In an example, operation 1220 may include generating the illumination map based on the spatial feature using the illumination estimation model.

In an example, operation 1230 may include extracting a spectral feature from the multispectral image using a spectral feature extraction model and estimating the confidence score map based on the spectral feature using a confidence estimation model.

In an example, the extracting of the spectral feature may include generating a spatial attention map based on a spatial feature of the multispectral image, generating a spectral attention map based on a spectral feature of the multispectral image, generating a cross attention map based on the spatial attention map and the spectral attention map, and generating the spectral feature using the cross attention map.

The multispectral image may be defined based on a width direction, a height direction, and a channel direction, the spatial feature may be extracted based on the width direction and the height direction, and the spectral feature may be extracted based on the channel direction.

In an example, the generating of the spatial attention map may include generating a query spatial feature based on a first spatial embedding of the multispectral image, generating a key spatial feature based on a second spatial embedding of the multispectral image, and generating the spatial attention map based on a matrix operation between the query spatial feature and the key spatial feature.

In an example, the generating of the spectral attention map may include generating a query spectral feature based on a first spectral embedding of the multispectral image, generating a key spectral feature based on a second spectral embedding of the multispectral image, and generating the spectral attention map based on a matrix operation between the query spectral feature and the key spectral feature.

The generating of the spectral feature may include generating a value spectral feature based on a third spectral embedding of the multispectral image and generating the spectral feature based on a matrix operation between the cross attention map and the value spectral feature.

The first color channels may include a red channel, a green channel, and a blue channel, and the second color channels may include a color channel between the red channel and the green channel, a color channel between the green channel and the blue channel, or a combination thereof.

FIG. 13 illustrates an example electronic device according to one or more embodiments.

Referring to FIG. 13, in a non-limiting example, an electronic device 1300 may include a processor 1310, a memory 1320, a camera 1330, a storage device 1340, an input device 1350, an output device 1360, and a network interface 1370 that may communicate with each other through a communication bus 1380. For example, the electronic device 1300 may be implemented as at least a part of a mobile device such as a mobile phone, a smartphone, a personal digital assistant (PDA), a netbook, a tablet computer or a laptop computer, a wearable device such as a smart watch, a smart band or smart glasses, a computing device such as a desktop or a server, a home appliance such as a television, a smart television or a refrigerator, a security device such as a door lock, or a vehicle such as an autonomous vehicle or a smart vehicle.

The processor 1310 may further execute programs, and/or may control other operations or functions of the electronic device 1300. The processor 1310 may be configured to execute programs or applications to configure the processor 1310 to control the electronic apparatus 1300 to perform one or more or all operations and/or methods involving image processing, and may include any one or a combination of two or more of, for example, a central processing unit (CPU), a graphic processing unit (GPU), a neural processing unit (NPU) and tensor processing units (TPUs), but is not limited to the above-described examples.

The memory 1320 may include computer-readable instructions. The processor 1310 may be configured to execute computer-readable instructions, such as those stored in the memory 1320, and through execution of the computer-readable instructions, the processor 1310 is configured to perform one or more, or any combination, of the operations and/or methods described herein. The memory 1320 may be a volatile or nonvolatile memory.

The camera 1330 may generate an input image and/or an input image set. The input image may include a photo and/or a video. The camera 1330 may include a visible light camera that generates a visible light image and an infrared camera that generates an infrared image. The visible light image and the infrared image may form the input image set. The storage device 1340 includes a computer-readable storage medium or computer-readable storage device. The storage device 1340 may store more information than the memory 1320 and may store the information for a long time. For example, the storage device 1340 may include a magnetic hard disk, an optical disc, a flash memory, a floppy disk, or other types of non-volatile memory known in the art.

The input device 1350 may receive an input from the user in traditional input manners through a keyboard and a mouse, and in new input manners such as a touch input, a voice input, and an image input. For example, the input device 1350 may include a keyboard, a mouse, a touch screen, a microphone, or any other device that detects the input from the user and transmits the detected input to the electronic device 1300. The output device 1360 may provide an output of the electronic device 1300 to the user through a visual, auditory, or haptic channel. The output device 1360 may include, for example, a display, a touch screen, a speaker, a vibration generator, or any other device that provides the output to the user. The network interface 1370 may communicate with an external device through a wired or wireless network.

The electronic devices, processors, memories, neural networks, first neural network model 110, second neural network model 120, spatial feature extraction model 310, illumination estimation model 320, spectral feature extraction model 410, confidence estimation model 420, first neural network model 710, second neural network model 720, first neural network model 810, second neural network model 820, encoders 910, 920, and 930, teacher network model 1010, student network model 1020, first neural network model 1110, second neural network model 1120, electronic apparatus 1300, processor 1310, memory 1320, camera 1330, storage device 1340, input device 1350, output device 1360, network interface 1370, and communication bus 1380 described herein and disclosed herein described with respect to FIGS. 1-13 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
converting an input image based on first sub-images of first color channels into a multispectral image based on second sub-images of second color channels;
generating an illumination map representing an illumination configuration of the input image, based on the input image;
generating a confidence score map of the illumination map, based on the multispectral image; and
determining illuminant information of the input image by fusing the illumination map with the confidence score map,
wherein a second number of channels of the second color channels is greater than a first number of channels of the first color channels.

2. The method of claim 1, wherein the generating of the illumination map comprises:
extracting a spatial feature from the input image using a spatial feature extraction model; and
generating the illumination map based on the spatial feature using an illumination estimation model.

3. The method of claim 1, wherein the generating of the confidence score map comprises:
extracting a spectral feature from the multispectral image using a spectral feature extraction model; and
generating the confidence score map based on the spectral feature using a confidence estimation model.

4. The method of claim 3, wherein the extracting of the spectral feature comprises:
generating a spatial attention map based on a spatial feature of the multispectral image;
generating a spectral attention map based on a spectral feature of the multispectral image;
generating a cross attention map based on the spatial attention map and the spectral attention map; and
generating the spectral feature using the cross attention map.

5. The method of claim 4, wherein the multispectral image is defined based on a width direction, a height direction, and a channel direction,
wherein the spatial feature is extracted based on the width direction and the height direction, and
wherein the spectral feature is extracted based on the channel direction.

6. The method of claim 4, wherein the generating of the spatial attention map comprises:
generating a query spatial feature based on a first spatial embedding of the multispectral image;
generating a key spatial feature based on a second spatial embedding of the multispectral image; and
generating the spatial attention map based on a matrix operation between the query spatial feature and the key spatial feature.

7. The method of claim 4, wherein the generating of the spectral attention map comprises:
generating a query spectral feature based on a first spectral embedding of the multispectral image;
generating a key spectral feature based on a second spectral embedding of the multispectral image; and
generating the spectral attention map based on a matrix operation between the query spectral feature and the key spectral feature.

8. The method of claim 7, wherein the generating of the spectral feature comprises:
generating a value spectral feature based on a third spectral embedding of the multispectral image; and
generating the spectral feature based on a matrix operation between the cross attention map and the value spectral feature.

9. The method of claim 1, wherein the first color channels comprise a red channel, a green channel, and a blue channel, and
wherein the second color channels comprise a color channel between the red channel and the green channel, a color channel between the green channel and the blue channel, or a combination thereof.

10. A processor-implemented method, the method comprising:
converting an input image based on first sub-images of first color channels into a multispectral image based on second sub-images of second color channels;
generating an illumination map representing an illumination configuration of the input image and a confidence score map of the illumination map, based on the multispectral image; and
determining illuminant information of the input image by fusing the illumination map with the confidence score map,
wherein a number of channels of the second color channels is greater than a number of channels of the first color channels.

11. The method of claim 10, wherein the generating of the confidence score map comprises:
extracting a spectral feature from the multispectral image using a spectral feature extraction model; and
generating the confidence score map based on the spectral feature using a confidence estimation model.

12. The method of claim 11, wherein the extracting of the spectral feature comprises:
generating a spatial attention map based on a spatial feature of the multispectral image;
generating a spectral attention map based on a spectral feature of the multispectral image;
generating a cross attention map based on the spatial attention map and the spectral attention map; and
generating the spectral feature using the cross attention map.

13. The method of claim 10, wherein the first color channels comprise a red channel, a green channel, and a blue channel, and
wherein the second color channels comprise a first spectral channel between the red channel and the green channel, a second spectral channel between the green channel and the blue channel, or a combination thereof.

14. A non-transitory, computer-readable storage medium storing instructions that, when executed by a processor, cause the processor to perform the method of claim 1.

15. An electronic device, comprising:
processors configured to execute instructions; and
a memory storing the instructions, wherein execution of the instructions configures the processors to:
convert an input image based on first sub-images of first color channels into a multispectral image based on second sub-images of second color channels;
generate an illumination map representing an illumination configuration of the input image, based on the input image;
estimate a confidence score map of the illumination map, based on the multispectral image; and
determine illuminant information of the input image by fusing the illumination map with the confidence score map,
wherein a number of channels of the second color channels is greater than a number of channels of the first color channels.

16. The electronic device of claim 15, wherein the one or more processors are further configured to:
extract a spectral feature from the multispectral image using a spectral feature extraction model; and
estimate the confidence score map based on the spectral feature using a confidence estimation model.

17. The electronic device of claim 16, wherein the one or more processors are further configured to:
generate a spatial attention map based on a spatial feature of the multispectral image;
generate a spectral attention map based on a spectral feature of the multispectral image;
generate a cross attention map based on the spatial attention map and the spectral attention map; and
generate the spectral feature using the cross attention map.

18. The electronic device of claim 17, wherein the one or more processors are further configured to:
generate a query spatial feature based on a first spatial embedding of the multispectral image;
generate a key spatial feature based on a second spatial embedding of the multispectral image; and
generate the spatial attention map based on a matrix operation between the query spatial feature and the key spatial feature.

19. The electronic device of claim 17, wherein the one or more processors are further configured to:
generate a query spectral feature based on a first spectral embedding of the multispectral image;
generate a key spectral feature based on a second spectral embedding of the multispectral image; and
generate the spatial attention map based on a matrix operation between the query spectral feature and the key spectral feature.

20. The electronic device of claim 15, wherein the first color channels comprise a red channel, a green channel, and a blue channel, and
wherein the second color channels comprise a first spectral channel between the red channel and the green channel, a second spectral channel between the green channel and the blue channel, or a combination thereof.
